(19) United States
(12) Patent Application Publication
(10) Pub. No.: US 2003/0010842 A1
(43) Pub. Date: Jan. 16, 2003

(54) Oscillating nozzle sprinkler with integrated adjustable arc, precipitation rate, flow rate and range of coverage

(76) Inventor: Carl L.C. Kah JR., North Palm Beach, FL (US)

Correspondence Address: OSTROLENK FABER GERB & SOFFEN, 1180 AVENUE OF THE AMERICAS, NEW YORK, NY, 100368403

(21) Appl. No.: 10/170,061

(22) Filed: Jun. 10, 2002

Related U.S. Application Data
(60) Provisional application No. 60/297,120, filed on Jun. 8, 2001.

(51) Int. Cl. B05B 3/00

(52) U.S. Cl. 239/225.1

(57) ABSTRACT

An oscillating nozzle sprinkler for directing an adjustable flow of water therefrom at adjustable desired range and arc of coverage and at a pre-settable precipitation rate. The desired flow rate or precipitation rate for a particular arc of coverage can be selected and the flow will then be automatically varied as the arc of sprinkler oscillation is adjusted to maintain the precipitation rate that was set. The nozzle discharge range is adjustable from the top with integrated flow control to automatically maintain the precipitation rate that was set constant as the range is changed for a smaller area of coverage due to the reduced range.

### FIELD OF THE INVENTION

This invention relates to oscillating nozzle sprinklers which are adjustable to select different arcs of coverage with an integrated selectable precipitation rate, flow rate and range of coverage.

### BACKGROUND OF THE INVENTION

In U.S. Pat. Nos. 4,867,378 and 4,901,924 sprinklers are disclosed that have adjustable arcs of oscillation and an indicator on the top of the nozzle that displays the selected arc angle. In U.S. Pat. No. 5,417,370 a reversing gear drive with settable arc of oscillation is disclosed. These patents illustrate several drive mechanisms for oscillating sprinklers in which the arc-of-coverage is easily adjustable, and which provide an indication of the selected arc angle on the top of the nozzle. Other types of drive mechanisms such as ball drives and reversing turbine gear drives can also be used in such sprinklers.

In U.S. Pat. No. 5,098,021 an oscillating nozzle sprinkler with integrated adjustability of both arc of coverage and flow is disclosed. In this patent, the selected flow rate (or the corresponding precipitation rate) is displayed on the top of the nozzle separately from the selected arc setting. This patent also discloses a nozzle configuration with an adjustable throat plug for changing the flow rate through the nozzle and various configuration for providing different water distribution patterns.

In U.S. Pat. No. 5,086,977, an oscillating water driven sprinkler is disclosed having a nozzle in which the stream elevation angle or spray range is adjustable from the top surface of the nozzle using a screw mechanism.

In U.S. Pat. No. 6,237,862, a nozzle configuration is shown in which the nozzle tube is surrounded by and attached to a flexible thin diaphragm. The shape of the diaphragm allows the nozzle tube to be effectively hinged so that deflecting the nozzle tube establishes a desired sprinkler steam exit angle.

Above-mentioned U.S. Pat. Nos. 4,867,378, 4,901,924, 5,417,370, 5,098,021, and 6,237,862 provide general, technical background, and further physical and mechanical background for the features and improvements of this invention, and are incorporated by reference herein as if fully disclosed.

None of these patents, however, nor any other sprinklers known to applicant, provide the capability for automatic adjustment of the flow to maintain a preset precipitation rate as the spray range and/or arc of coverage is adjusted. In some instances, stream break-up screws have been provided, but there has been no way to maintain a constant precipitation rate if a pre-selected spray range or arc of coverage was changed in the field, or even to know how the precipitation rate was affected by such changes without performing a laborious calculation, which was rarely, if done in practice.

This can be a significant inconvenience in some instances. For example, in arranging uniform coverage of the area under irrigation, the sprinklers are often arranged in a triangular pattern, and adjusted for maximum range. Sometimes, however, best coverage can be obtained with a square or in-line pattern, or with combinations of sprinklers grouped in different patterns. In addition, the installer may need to adjust the ranges and arc angles of some or all of the sprinklers at the time of installation for different. Since it is important that the precipitation rates of individual sprinklers or groups of sprinklers be matched for uniform precipitation, and the flow for a given precipitation rate varies with the spray range and arc angle, it has been practically impossible to preset the flow for a desired precipitation rate. It has thus been customary to install different nozzles at different locations in complex layouts in order to achieve reasonably uniform precipitation.

A need clearly exists for a sprinkler in which the arc angle, spray range, and precipitation rate are adjustable, and in which a desired precipitation rate can be set and maintained by automatic changes in the flow rate as adjustments of the arc angle and spray range are made by the user.

### SUMMARY OF THE INVENTION

It is accordingly an object of this invention to provide an oscillating nozzle sprinkler in which the arc angle and precipitation rate are adjustable, and in which a desired precipitation rate can be set and maintained by automatic changes in the flow rate as adjustments of the arc angle are made by the user.

It is also an object of this invention to provide an oscillating nozzle sprinkler in which the spray range and precipitation rate are adjustable, and in which a desired precipitation rate can be set and maintained by automatic changes in the flow rate as adjustments of the spray range are made by the user.

It is a further object of this invention to provide an oscillating nozzle sprinkler in which the arc angle, spray range, and precipitation rate are adjustable, and in which a desired precipitation rate can be set and maintained by automatic changes in the flow rate as adjustments of the arc angle and spray range are made by the user.

It is an object of this invention to provide oscillating nozzle sprinklers as described above in which adjustments can be made from the top of the nozzle.

It is a related object of this invention to provide oscillating nozzle sprinklers as described above in which indicators are provided on the top of the nozzle to show the selected settings for the arc angle, the spray range and the precipitation rate.

These objects are achieved by coupling an adjustable flow control mechanism to separate independently adjustable spray range and arc control mechanisms. Rotatable members representing each of these functions are provided on the top of the sprinkler nozzle housing so that they may be set relative to each other on a precipitation rate scale located between the rotatable members.

Now the flow rate can set relative to the arc and to the maximum spray range to provide a desired precipitation rate, and if the arc angle is increased or decreased, the flow automatically increases or decreases to compensate for the change and to maintain the preset relative precipitation rate. Similarly, if the spray range is reduced from its maximum value, the flow is correspondingly decreases so that, again, the precipitation rate does not change.

Thus, with the sprinkler according to this invention, a preset relative known precipitation rate can be maintained for all arc settings and range of coverage, and complex calculations and field adjustments of flow rate can be avoided.

The indication on the top of the sprinkler will allow all of the sprinklers used in a particular irrigation zone which all run at the same time at approximately the same pressure to be correctly set relative to each other. While the exact numbers as indicated will vary as the square root of the pressure from that of the sprinkler's design normal pressure. However, these differences are small unless pressure is greatly different from design and the sprinklers will all be performing relative to each other for that irrigation zone where they are all turned on and off together.

Different scales can even be provided for high pressure or low pressure sprinklers.

Likewise, the installer can set sprinklers operating in groups relative to each other for the same precipitation (matched precipitation) which is what is most important and sprinklers whose range must be shortened will then flow the correct amount of water without having to change nozzles.

Other features and advantages of the present invention will become apparent from the following description of the invention which refers to the accompanying drawings.

### BRIEF DESCRIPTION OF THE DRAWING(S)

FIG. 1 is a cross-sectional side elevation view of a rotatable sprinkler nozzle assembly, with the nozzle housing assembly mounted on a partially sectioned riser assembly showing the rotatable nozzle assembly drive shaft arrangement and the significant components of the arc set, nozzle flow control, precipitation rate setting and nozzle range adjustment mechanism. The nozzle flow throttling member is shown in the full open position.

FIG. 2 is a top view of the nozzle assembly housing of FIG. 1 showing the location of the adjustments and flow rate, precipitation rate, arc set angle and range indicators.

FIG. 3 is a side elevation view of the nozzle housing assembly showing the adjustable flow area nozzle in place.

FIG. 4 shows the nozzle assembly of FIG. 1 with the nozzle flow throttling member shown in the full throttle position for the nozzle stream tube angle as shown.

FIG. 5 is a top view of a modified the nozzle assembly having a different flow adjustment and indicator pattern from that of FIG. 2.

FIG. 6 shows the nozzle housing assembly of FIG. 4 with the range control screw turned full down to cause the nozzle tube to be rocked and further throttling the nozzle throat flow for the now reduced area of coverage.

FIG. 7A is a top view of the nozzle throat throttling member.

FIG. 7B is an end elevation of the throttling member.

FIG. 8 is a top view of a further modification of the nozzle adjustment and indicting mechanisms.

### DETAILED DESCRIPTION OF EMBODIMENTS OF THE INVENTION

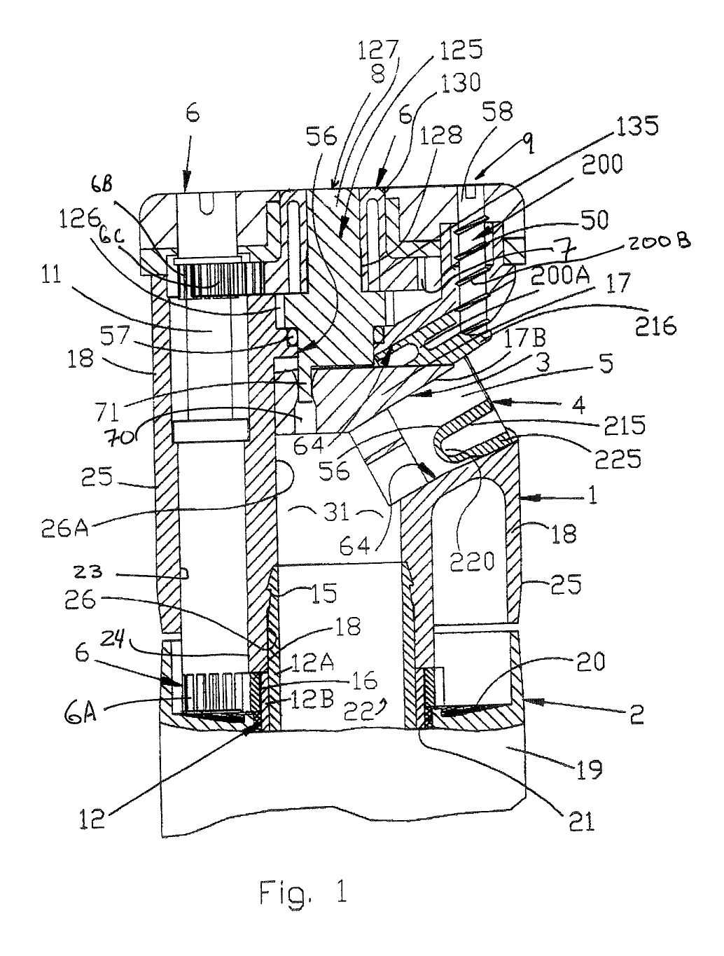

Referring to FIG. 1, a rotatable sprinkler nozzle assembly 1 is shown mounted on a cylindrical riser assembly 2 which includes a suitable rotary drive mechanism (not shown) for driving sprinkler nozzle assembly 1.

Details of arc-settable oscillating rotary-drive sprinklers of the type shown in FIG. 1 are set forth in U.S. Pat. Nos. 5,417,370, 4,901,924 and 4,867,378, incorporated herein by reference above. However, this invention is applicable to any arc-settable rotary-drive sprinkler including reversing gear or reversing turbine or ball drive mechanisms shown in U.S. Pat. Nos. 3,526,363 and 4,625,914, for example.

Riser assembly 2 includes a housing 19 with a top cover 20. An opening 21 at the center of cover 20 receives a hollow rotatable output nozzle drive shaft 12 including concentric shaft portions 12A and 12B extending from the drive mechanism. Water from a supply (not shown) is directed to hollow shaft opening 22 into the rotatable sprinkler nozzle assembly 1.

The rotatable sprinkler nozzle assembly 1 is comprised of the following main parts; a cylindrical nozzle housing 18, a nozzle 4, a nozzle flow throttling member 3, and an adjustable arc setting device 6 including rotatable arc setting shaft 11 for setting the arc of oscillation of the drive assembly, a flow setting and indicating assembly generally denoted at 8 including two concentric shafts 125 and 130 whose top surfaces and relative rotational position indicate the precipitation rate that has been set, and a range control adjustment mechanism generally denoted at 9.

The cylindrical nozzle housing 18 has an outer surface 25 approximately the same diameter as that of riser assembly 2. The interior of the nozzle housing 18 is formed having an upper closure area 22 with a lower annular open area 23 formed around a cylindrical downwardly extending projection 24 extends just below the bottom edge of the cylindrical outer surface 25 of the nozzle housing 18, and has a cylindrical opening 26 to receive the hollow rotatable output nozzle drive shaft 12 of the drive assembly in the riser assembly 2. The rotatable sprinkler nozzle assembly 1 is fixed to the inner hollow rotatable output nozzle drive shaft section 12A by a snapping step at 15.

A gear 6A at the lower end of arc setting shaft 11 engages with a complementary gear 16 on an outer nozzle drive shaft portion 12B. Gear 16 rotates outer nozzle drive shaft 12B which, in turn, move one of the arc control contact members of the oscillating drive mechanism housed in the riser housing 19. A second arc control contact is connected to an inner drive shaft portion 12A.

The arc-settable rotational drive including the two control contacts is shown and described in the aforementioned U.S. patents incorporated by reference above.

Precipitation rate is a volume per unit time (gallons per minute) applied over a particular area. Thus, if the arc of coverage is changed or the range of coverage is changed the flow rate must be changed to maintain the same precipitation rate. To provide the necessary coupling between the arc setting and the flow rate, a second gear 6B at the upper end of shaft 11 engages with a complementary gear 7 on shaft 130 through an intermediate gear 6C, as described below. The coupling between the range adjustment and the flow rate is provided by a rotatable shaft 200 which is part of range adjusting mechanism 9, and a throttle adjusting plug 17, also as described below.

A cylindrical opening 64 extends from the top portion of a central cavity flow area 31, formed by the cylindrical opening 26A in the nozzle housing, to the outside surface 25 of the cylindrical nozzle housing at an upwardly sloped angle of, for example, 25 to 27 degrees for holding the nozzle 4.

A passage 56 at the top of central cavity flow area 31 communicates with an upper cavity area 50. Within this, the rotational elements of the flow control and the connecting gearing are mounted.

Rotatable shaft 125 of flow control mechanism 8 includes an off centered crank pin 71 at its lower end. This fits into a camming slot 70 formed on throttling plug 3. Pin 71 and slot 70 cooperate to move the throttling plug 3 in and out of the throat area 5 of the nozzle 4, thereby to vary the nozzle flow area. The shaft is sized to be fitted into hole 56 of the nozzle housing 18 and sealed by “0” ring 57.

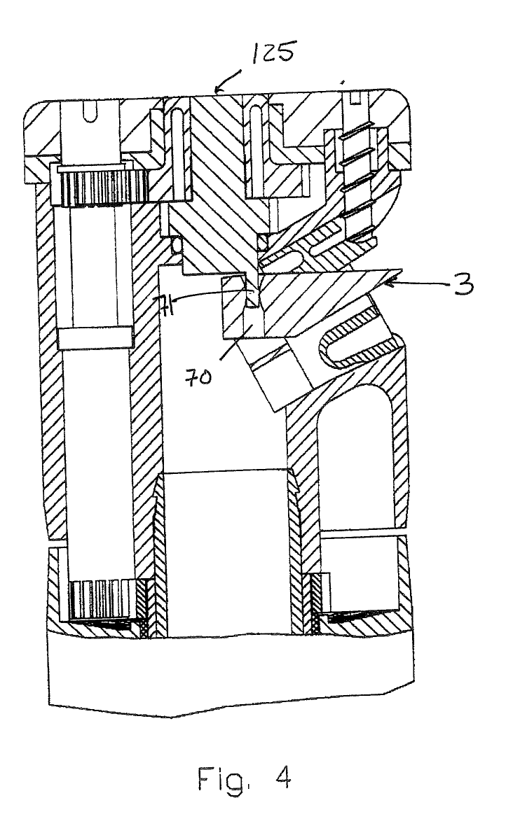

FIG. 1 shows pin 71 in the position corresponding to the maximum retracted position for throat plug 3, i.e., corresponding to maximum flow for the full range setting as described in detail below. By way of comparison, FIG. 4 shows pin 71 in the position corresponding to the maximum extended position for throat plug 3, i.e., corresponding to minimum flow for the full range setting

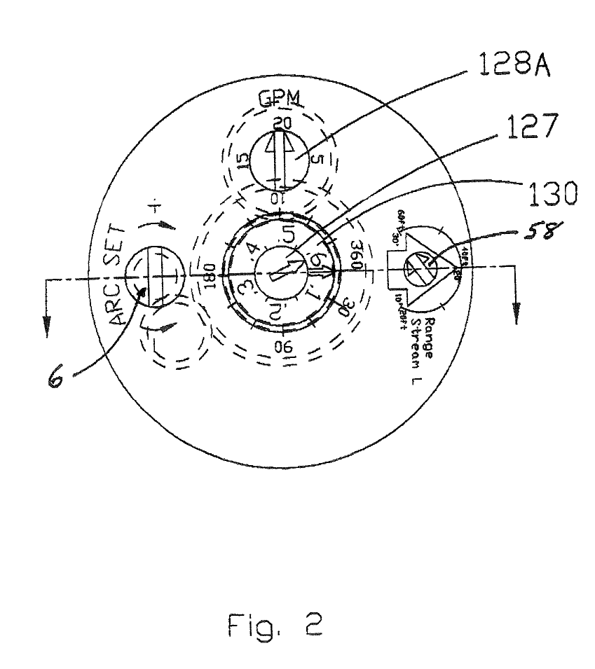

Shaft 125 includes a toothed portion or a gear 126 which allows transferring its rotational position to another rotary shaft 128A as shown in FIGS. 1 and 2. Since shaft 125 moves throat plug 3, its rotational position is representative of the flow rate through the sprinkler. Shaft 128A may thus be employed to set and/or indicate the flow rate.

Shaft 125 has an upper shaft portion 127 extending to the top of the sprinkler nozzle housing which can also be used for setting and/or indicating the flow control shaft position. Upper shaft portion 127 of flow control shaft 125 is coupled by serrations 128 to arc set indicator shaft 130. Rotation of arc set indicator shaft 130 thus rotates flow control shaft 125. Arc set indicator shaft 130 includes a thin slitted cylindrical wall section 135. This cooperates with serrations 128 to provide a frictional clutch mechanism which allows shaft 125 to be rotated separately from shaft 130.

The arc of coverage setting made by adjustment of mechanism 6 as previously described, is maintained by friction resulting from the fit of shaft 11 in nozzle housing 18, and the fit of concentric shafts 12A and 12B.

The arc setting is frictionally locked by the relatively close fit between concentric nozzle drive shafts 12A and 12B which transfers the arc setting. This friction is made to be greater than that to rotationally set the flow control shaft 125 so that the flow can be adjusted without changing the arc set shaft position. Likewise, rotation of shaft 11 will carry shaft 125. Since the position of shaft 125 determines the flow as described below, the flow automatically changes from a preset value as the arc of oscillation is adjusted. Thus, the relationship of flow to the arc of oscillation, i.e., the relative precipitation rate for the sprinkler, which determines how much water is put down for the area being covered by the set oscillation of the nozzle, can be maintained substantially unchanged. Similarly, the rotational relationship between shafts 127 and 130 can be used to provide an approximate precipitation rate for the sprinkler and can be an exact precipitation rate at a particular sprinkler supply pressure and nozzle stream angle (range).

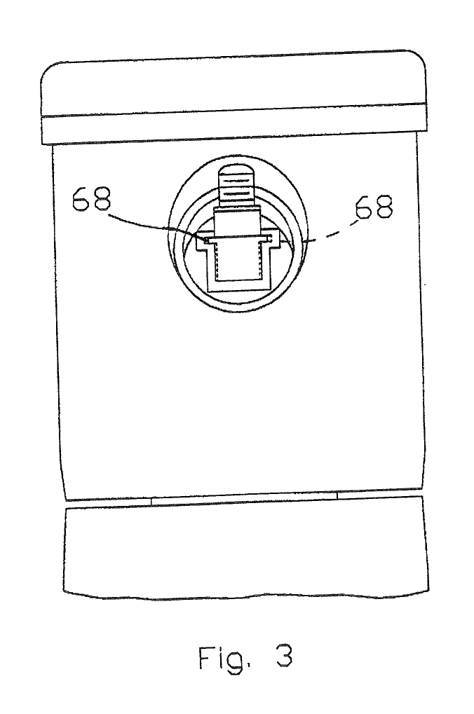

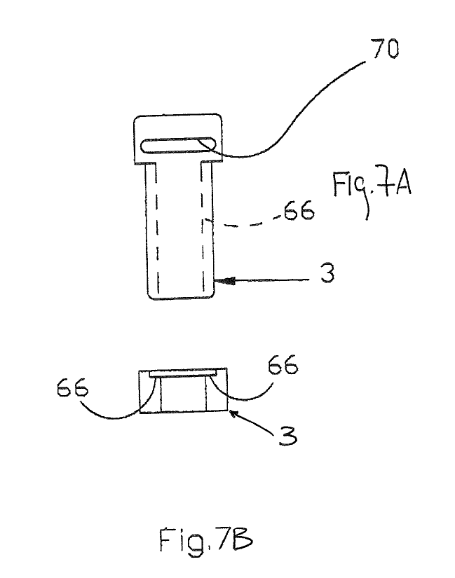

As shown in FIGS. 1, 3, 7A and 7B, nozzle 4 includes a primary flow opening nozzle throat 5 with its lower end formed as a semi-circle 5A or flat. A rectangular opening 5B extending upwardly from the lower end of throat 5 to receive a rectangular plug 17 which extends substantially parallel to the axis of cylindrical opening 64 along the upper side of nozzle flow throttling member 3. Rectangular opening 5B extends upwardly to a straight surface 5C which, in turn, extends through fixed nozzle 4 along line A from the front end to the rear end thereof.

Guide ribs 66 to each side of member 17 vertically position the throttling member 3 in grooves 68 in the nozzle 4. These ribs 66 on either side of plug 17 maybe used to throttle the secondary near field spray flow of the nozzle as described for the throttling nozzle of the above-referenced U.S. Pat. No. 5,098,021.

The range setting mechanism 9 and the manner in which it is coupled to the flow control mechanism 8 will now be described. As previously noted, such coupling permits the flow rate for a preset full range precipitation rate to vary with the stream exit elevation angle so that the precipitation rate remains approximately the same the range of coverage is varied.

The range adjusting mechanism 9 comprises a range control shaft 200 which may include a slotted head 58 accessible at the top of the nozzle as shown in FIGS. 1 and 2. Shaft 200 includes a threaded portion 200B extending along its length, which engages with a complementary threaded portion in nozzle housing 18 whereby shaft 200 moves up and down into the nozzle opening 64 as slotted head 58 is rotated.

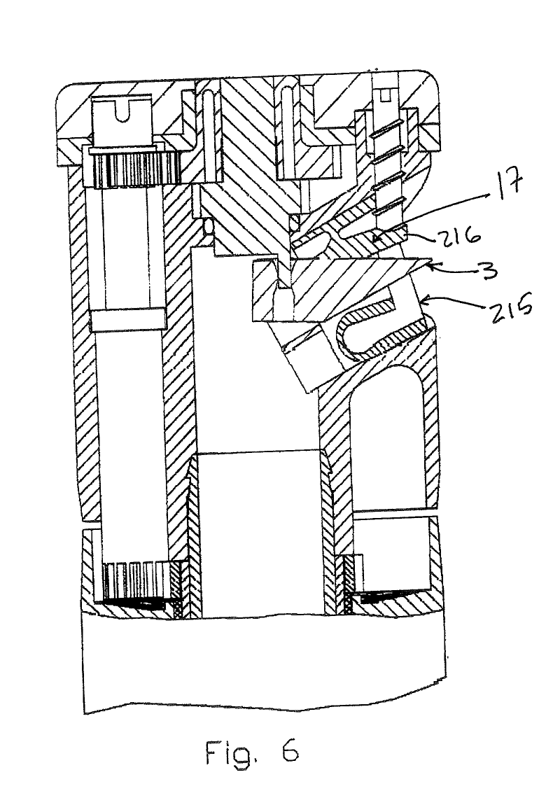

The lower end of shaft 200 engages with a leg portion 216 at the outer end of plug 17. As shown in FIGS. 1 and 6, as shaft 200 moves down, it deflects leg 216 downward, which, in turn, deflects plug 17. The movement of plug 17, in turn, causes a nozzle tube 215 located inside the bottom portion of the throat area 5C to be rocked downwardly.

As can be seen in FIG. 6, as the nozzle tube 215 is rocked downwardly, the clearance between the inside bottom portion of throat area 5C and throttling member surface 17B is reduced. This reduces the flow area, and maintains the preset full range precipitation rate as range is reduced. The flow control mechanism itself is described more fully in the above-mentioned U.S. patents incorporated herein by reference.

Although a specific embodiment has been described, other embodiments and variations a possible within the scope of the invention. For example, moving the nozzle tube 215 downwardly can also be used to throttle the secondary spray flow of slot 68, as described fully in the above-mentioned U.S. patents incorporated herein by reference.

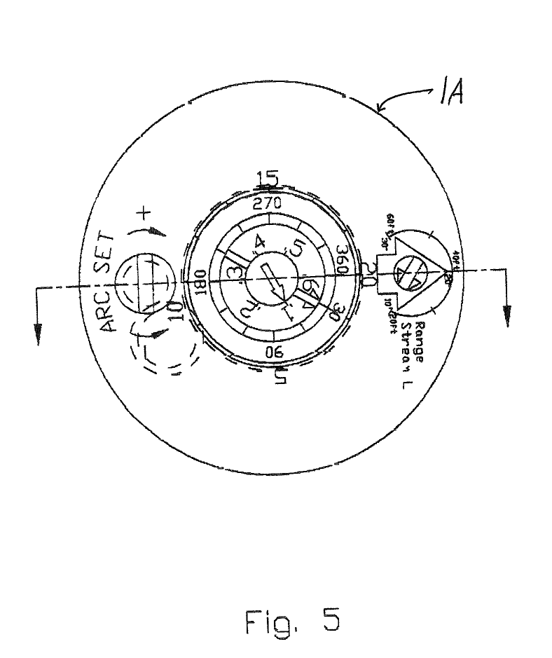

Also, the indicator configuration as illustrated in FIG. 2 can be modified. As an example, FIG. 5 illustrates a top view of a nozzle assembly 1A in which a separate flow indicator is not employed. Instead, the flow setting shaft is incorporated into the center flow and precipitation indicator shaft.

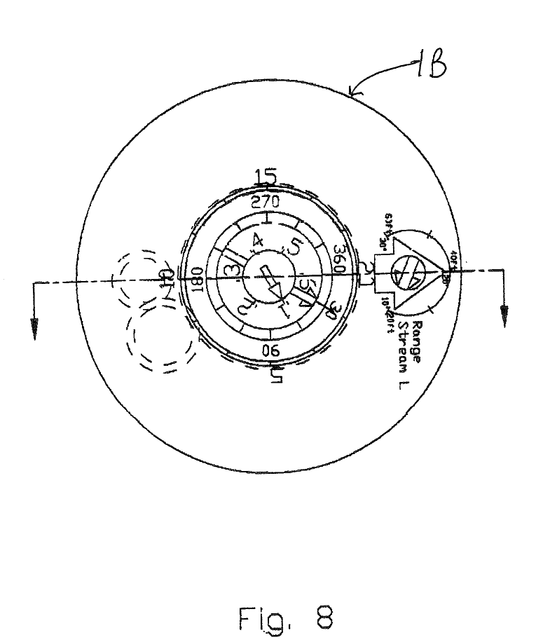

Similarly, FIG. 8 shows a top view of a nozzle assembly 1B in which the separate arc setting shaft has been eliminated from the top and the arc set, precipitation rate settings and indications are provided by only the two center flow and arc connected shafts.

In this connection, in the configurations described, the flow rate indicator is coupled only to the arc setting mechanism, and not to the range setting mechanism. Thus, compensating change in the flow rate as the arc of oscillation is adjusted are indicated, but changes in flow rate as the range is adjusted are not shown. By providing coupling between the range adjusting mechanism 9 and the flow indicator, flow changes with range adjustment can also be indicated in the configurations of FIGS. 2, 5, and 8.

Moreover, while there has been disclosed as a single nozzle configuration with a rectangular moving plug to vary flow nozzle as the range is adjusted, other configurations can be envisioned which will provide coupling between the flow for a preset full range precipitation rate and the range adjustment.

Although the present invention has been described in relation to particular embodiments thereof, many other variations and modifications and other uses will become apparent to those skilled in the art. It is intended, therefore, that the present invention be limited not by the specific disclosure herein, but only by the appended claims.

What is claimed is:

1. A rotary driven nozzle sprinkler with adjustable arc of coverage its variable flow area actuation member operationally connected to the arc of coverage actuation member so that the flow area is increased or decreased as the arc of coverage is increased or decreased but with disconnection clutch so that the flow area may be independently adjusted relative to a particular arc of coverage to establish a desired flow per arc area of coverage.

2. A sprinkler as in claim 1 where the relative approximate precipitation rates for the sprinkler may be set and indicate as a relationship between operationally connected flow and arc of oscillation members.

3. A sprinkler as in claim 1 where the stream discharge angle can be changed to reduce range and is operationally configured to also reduce the flow rate through the nozzle in order to maintain approximately the same precipitation rate as set.
